(19) United States
(12) Patent Application Publication
(10) Pub. No.: US 2014/0126532 A1
(43) Pub. Date: May 8, 2014

(54) SEAMLESS MOBILITY FROM 3G NETWORK TO WIFI NETWORK

(71) Applicant: STOKE, INC., Santa Clara, CA (US)

(72) Inventors: Anil Bapat, Bangalore (IN); Mukesh Garg, Cupertino, CA (US); Tamanna Jindal, Bangalore (IN)

(73) Assignee: STOKE, INC., Santa Clara, CA (US)

(21) Appl. No.: 13/669,220

(22) Filed: Nov. 5, 2012

(51) Int. Cl. H04W 36/18

(52) U.S. Cl. 370/331

(57) ABSTRACT

According to one aspect, a multi-function gateway device (MFG) receives a request for terminating a first data session identified by a first IP address, the request originating either directly from a user equipment (UE), or indirectly from the UE via a radio access controller (RNC), wherein the UE is communicatively coupled to a 3G radio access network (RAN), such that data traffic of the first data session is routed to a first serving GPRS support node (SGSN). According to one aspect of the invention, the MFG further determines whether the UE is connected to the MFG via a WiFi RAN, any 3G call teardown related messages are blocked in order to keep the 3G GTP-U tunnel up. Continue routing user's data originating via the WiFi RAN over the GTP-U tunnel with the SGSN.

### FIELD OF THE INVENTION

The present invention relates generally to packet networks. More particularly, this invention relates to a method for providing seamless mobility as a user equipment (UE) moves from a 3G radio access network to a WiFi radio access network.

### BACKGROUND

Most of the mobile operators have 3G and 4G networks. However, due to radio spectrum scarcity, operators are using, or planning to use, indoor and outdoor WiFi to increase the data network coverage and offer better QoE (Quality of Experience) to the end user. This is logical since WiFi has become the networking technology of choice at home and at enterprises for wireless users. It is also abundantly present at locations of nomadic computing such as cafes, airports and hotels. The leveraging of the ubiquitous WiFi networks to increase data network coverage also makes sense because modern devices used by mobile user base (e.g., Smartphone, tablet, and laptop) are capable of using both WiFi and cellular network.

When a user equipment (UE) moves from a 3G universal mobile telecommunications system (UMTS) network to a WiFi hotspot, seamless mobility is not supported by the operators, because there is no guarantee from the data network that the User Equipment (UE) will be granted the same IP address. Due to the lack of seamless mobility, data sessions are dropped when a UE moves from a 3G to WiFi access network even though the same service provider provides both the services.

### BRIEF DESCRIPTION OF THE DRAWINGS

The present invention is illustrated by way of example and not limitation in the figures of the accompanying drawings in which like references indicate similar elements.

FIG. 1A is a block diagram illustrating an internetworked WiFi RAN and 3G RAN system according to one embodiment.

FIG. 1B is a block diagram of the internetwork of FIG. 1A after UE 101 has detached and connected to 3G Core Network (CN) via a WiFi RAN.

FIG. 2 is a flow diagram illustrating a method for seamlessly processing handover from a 3G RAN to a WiFi RAN according to one embodiment of the invention.

FIG. 3 is a block diagram of an IP mapping table.

FIG. 4 is a transaction diagram illustrating a UE establishing a 3G data session via a 3G RAN.

FIG. 5 is a transaction diagram illustrating a UE establishing a 3G data session via a WiFi RAN.

FIG. 6 is a transaction diagram illustrating a UE/RNC attempting to deactivate a 3G data session that exists via a 3G RAN, after it has established a 3G data session via a WiFi RAN.

FIG. 7 is a block diagram illustrating a multi-functional gateway device according to one embodiment of the invention.

### DETAILED DESCRIPTION

In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention. Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

According to some embodiments of the invention, an embodiment of the invention provides an architecture and set of mechanisms to enable seamless mobility as a UE roams from a 3G radio access network (3G RAN) to a WiFi radio access network (WiFi RAN). Seamless mobility in this case refers to the fact that the user's existing data session on the 3G network is not disturbed, or dropped when the UE switches over to the WiFi RAN. In one embodiment, the seamless mobility of the UE is achieved by a multi-functional gateway (MFG) which straddles a 3G RAN and WiFi RAN. It will be apparent in the description provided herein that the MFG is able to process the standard interface protocols/messages that are employed by each of the RANs.

In one embodiment, the UE establishes a 3G data session (e.g., a web browsing session) by first attaching, i.e., connecting, to a 3G RAN which is coupled to the MFG. In response to receiving a request from the UE to establish a data session, the MFG relays the request to a 3G core network (CN). In one embodiment, the MFG interfaces with the 3G CN through a serving GPRS support node (SGSN), which in turn interfaces with a gateway GPRS support node (GGSN) for accessing an IP network, such as the Internet. In response to the request for creating a data session, the 3G CN assigns/allocates the UE a unique IP address, which is communicated to the UE via the MFG. In addition to forwarding this IP address to the UE, the MFG may also update a local IP mapping table to indicate that the UE is currently connected to the 3G CN. In one embodiment, this is done by updating the IP mapping table with a unique identifier of the UE, e.g., an international mobile subscriber identifier (IMSI). Thus, the existence of a particular UE's IMSI in the IP mapping table indicates to the MFG that the UE has an active data session with the 3G CN. In one embodiment, the MFG also includes the UE's assigned IP address in its corresponding entry in the IP mapping table.

In one embodiment, after establishing a 3G connection via the 3G RAN, the UE will initiate a handover, i.e., switch from the 3G RAN to another RAN. For example, the UE moves within range of a WiFi RAN and decides to connect to it, by first authenticating with the local WiFi access point (AP). Upon completing the authentication process with the WiFi AP, the UE may establish a new data session by connecting to either a packet data gateway (PDG) or a tunnel termination gateway (TTG), either of which may be implemented in the MFG. In either case, the UE first authenticates with a 3G authentication, authorization, and accounting (AAA) server. If the authentication with the AAA is completed successfully, a new IP address will be assigned to the UE either by the PDG or the TTG. Due to the fact that a new IP address is being assigned to the new data session, the user's existing data connection (e.g., his/her web browsing) will be interrupted. For instance, the user may have to refresh the web browser, and possibly re-enter sign in credentials such as username and password, if the particular web site he/she is visiting requires such credentials.

In one embodiment, the MFG provides seamless mobility by preventing the new data session from being identified by a new IP address. In one embodiment, the MFG will intercept and parse/process the exchange messages between the UE and the PDG/TTG via the WiFi RAN. In particular, the MFG may process the messages to determine if the UE currently has a 3G data session through the 3G RAN. In one embodiment, this is done by looking up the IP mapping table to determine if the UE's IMSI exists in the table, and if so, the MFG concludes that the UE is already connected to the 3G CN for an existing data session. In response to determining that the UE has an existing 3G data session through the 3G RAN, the MFG may update the IP mapping table to further indicate that the same UE is now connected to the 3G CN via WiFi RAN, i.e., the UE's data session over the WiFi RAN is a handover data session. In one embodiment, in response to determining that the UE has an existing data session through the 3G RAN, the MFG will forward to the UE the same IP address that was assigned to it on the 3G RAN side, rather than forwarding the new IP address that was assigned to the UE by the PDG/TTG. In one embodiment, the IP address forwarded to the UE is the IP address located in the IP mapping table, at the UE's entry, i.e., the entry containing the IMSI of the UE.

In one embodiment, the UE determines that it has successfully established a second data session through the WiFi RAN (i.e., it has succeeded the handover procedure) and decides to tear down the first 3G data session, i.e., the data session established through the 3G RAN. In one embodiment, the tear down may be achieved by the UE or RNC sending messages to the 3G CN to deactivate the data session. In one embodiment, the messages sent by the UE, or the 3G RNC on the UE's behalf, to the 3G CN to terminate the first data session are intercepted by the MFG. In such an embodiment, the MFG determines if the session termination request originates from a UE that is currently attached to the 3G CN via the WiFi RAN, e.g., by looking up the UE's IMSI in the IP mapping table. In one embodiment, in response to determining that the request to terminate a data session originates from a UE that is attached to the 3G CN via the WiFi RAN (i.e., the UE has a handover session via the WiFi RAN), the MFG blocks the requests and prevent them from being forwarded to the 3G CN. In other words, the first data session between the UE and the 3G CN is left uninterrupted. Thus, the GTP tunnel between the UE and 3G CN via 3G RAN remains active.

In one embodiment, the UE will continue its data session through the WiFi RAN, using the IP address that was assigned by the MFG, i.e., the original IP address from the first data session through the 3G RAN. In one embodiment, the MFG will parse data packets from the UE via the WiFi RAN to determine if the data session is a handover session, e.g., by performing an IMSI-based look up of an IP mapping table. If so, the MFG may route all data packets from the UE to the SGSN, rather than routing the data packets to the PDG/TTG. In one embodiment, the MFG determines that the session is a result of a handover if the UE's IMSI exists in the IP mapping table entry, and the entry contains information indicating that the UE has performed a handover.

In one embodiment, any attempted handover from 3G RAN to WiFi RAN results in the UE continuing its data session (e.g., current session) using the same IP address from the 3G RAN data session and data packets continue to be routed through the same original path, e.g., through the SGSN. Thus, from the user's perspective, the handover is seamless, and the data session is uninterrupted. For instance, referring back to the web browsing example above, the user may not be required to refresh his/her browser, or re-enter his/her username and password.

In one embodiment, the UE terminates its handover data session via the WiFi RAN by sending messages to the PDG/TTG. In such an embodiment, the MFG may parse these messages and update the IP mapping table to indicate that the UE is no longer connected to the 3G CN via the WiFi RAN, e.g., by removing the UE's IMSI from the table. Alternatively, the UE may simply go off-line without sending any messages to tear down the handover data session. In such an embodiment, after a predetermined period of inactivity by the UE, the 3G CN may send messages to the UE which may be intercepted and interpreted by the MFG that the UE is no longer attached to the 3G CN via the WiFi RAN, and the MFG updates the IP mapping table by removing the UE's IMSI from the table. Alternatively, the MFG may maintain its own timer and determines on its own that the UE has been inactive for a predetermined period of time, and removes the UE's IMSI from the IP mapping table to indicate that the UE is no longer attached to the 3G CN via the WiFi RAN. Although the IMSI is used in these examples as a unique UE identifier, it will be appreciated that other unique UE identifiers may be used.

In one embodiment, the UE decides to establish another data session through the WiFi RAN after its IMSI has been removed from the IP mapping table, i.e., a completely new data session, as distinguished from a data session resulting from a handover. In such a case, the new session will be created from scratch, and will not be treated as a handover attempt. For instance, upon concluding that the UE IMSI is not in the IP mapping table, the MFG will not swap IP addresses, i.e., the MFG will simply forward the IP address assigned to the UE by the PDG/TTG. Moreover, the data session will be routed to the PDG or TTG, rather than the SGSN.

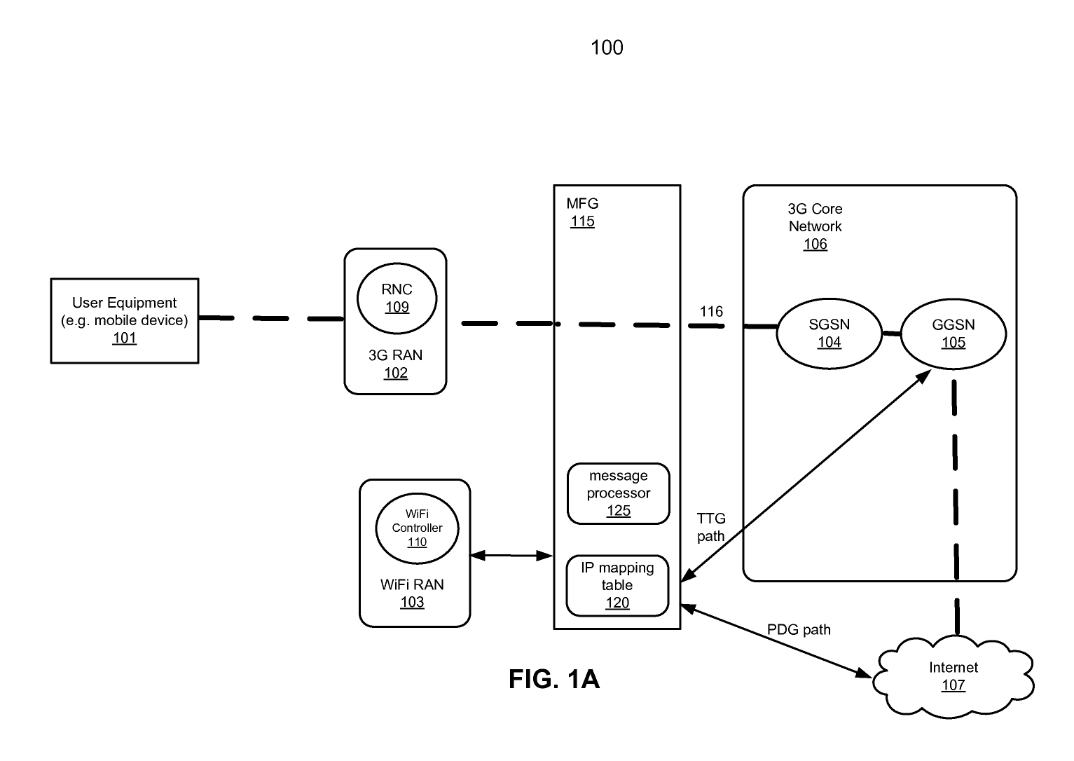

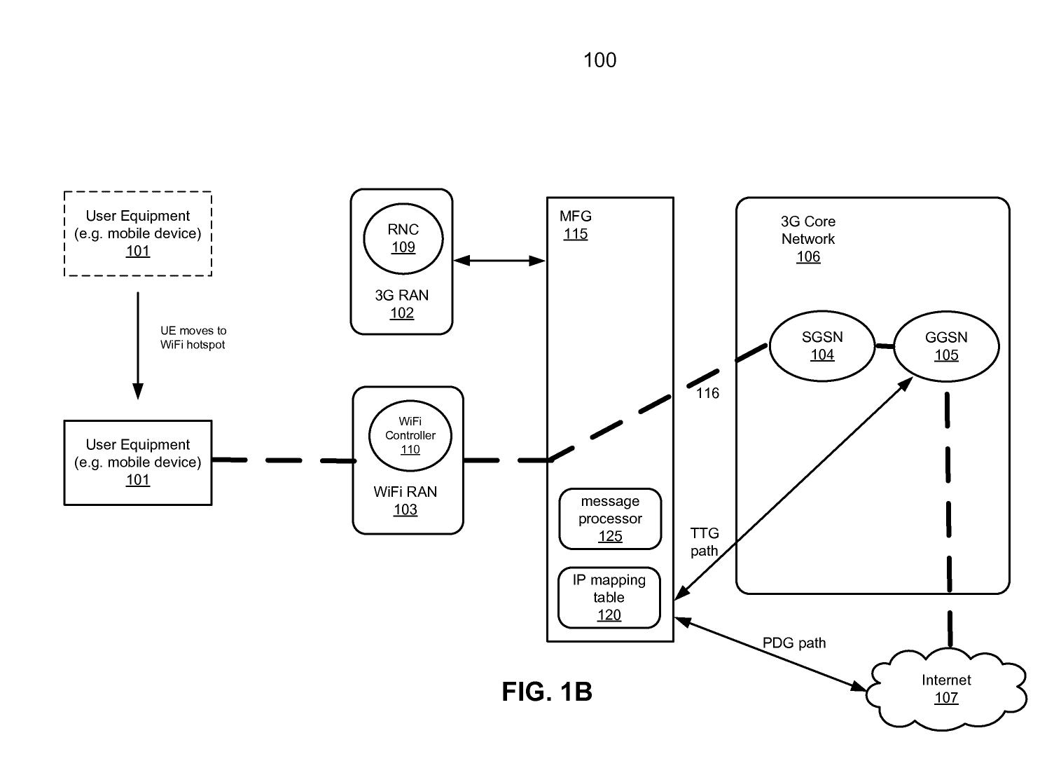

FIG. 1A is a block diagram illustrating an internetworked WiFi RAN 103 and 3G RAN 102 systems according to one embodiment. Referring to FIG. 1A, user equipment (UE) 101 is communicatively coupled to a RNC 109 of 3G RAN 102. In order to access other networks such as Internet 107, UE 101 has to go through gateway device 115 and/or 3G packet core network 106. Typically, 3G packet core network 106 includes a serving GPRS support node (SGSN) 104 and a gateway GPRS support node (GGSN) 105. These SGSNs and GGSNs relay communications between a user terminal (or source mobile station) and a destination. Note that typically, there may be multiple SGSNs associated with a GGSN, multiple RNCs associated with a SGSN, and multiple UEs associated with an RNC in a hierarchical structure (not shown).

SGSN 104 and GGSN 105 include a function of relaying communications between a user terminal (or source mobile station) and a destination node (e.g. a server in the Internet or another mobile station). SGSN 104 effects data transmission between UE 101 and GGSN 105. For example, SGSN 104 collects up-link sessions from RNC 109 and distributes the down-link session delivered from GGSN 105 toward RNC 109. SGSN 104 manages a packet service between SGSN 104 and GGSN 105 by tunneling (e.g., GPRS tunneling protocol or GTP). SGSN 104 receives a subscriber profile stored in a home location register (HLR) and has therein at any time a copy thereof. The subscriber profile has information about the subscribed services (Internet, operator walled garden, etc.)

GGSN 105 functions as a logical interface to an external data packet network such as Internet 107 and/or operator services node. GGSN 105 operates for coupling between core network 106 and such external packet data networks. More specifically, GGSN 105 collects up-link sessions from SGSN 104 and accesses Internet 107 and/or operator services. GGSN 105 in the 3G packet core network 106 sets up a tunnel down to SGSN 104 for down-link sessions.

In one embodiment, MFG 115 also supports PDG and/or TTG mode. In PDG mode, data traffic originating from UE 101 via WiFi RAN 103 is routed directly to an external network such as Internet 107 without going through 3G CN 106, thus offloading the 3G network. In TTG mode, data traffic originating from UE 101 via WiFi RAN 103 is routed to GGSN 105 which is then routed to an external network such as Internet 107.

UE 101 may be any of a variety of mobile devices, such as a Smartphone, tablet, a laptop, a gaming device, and/or a media device, etc., having the capability of communicating with MFG 115 via a variety of RANs. In one embodiment, UE 101 can also access MFG 115 via WiFi controller 110 of WiFi RAN 103. UE 101 can roam between RAN 102 and RAN 103 while maintaining the same communications session (e.g., mobility) with a remote entity such as operator service node or Internet 107.

In one embodiment, MFG 115 includes a message processor 125, such as a packet inspector, which intercepts messages (data packets) exchanged between UE 101 and 3G CN 106. In particular, message processor 125 intercepts IP assignment messages from SGSN 104 directed at UE 101. In such an embodiment, message processor 125 parses the messages to look up the IP address that has been assigned to UE 101 by GGSN 105. In one embodiment, message processor 125 updates IP mapping table 120 to include the assigned IP address and corresponding unique identifier of UE 101, e.g., an IMSI. Thus, in one embodiment, IP mapping table 120 indicates to MFG 115 whether a particular UE currently has an active data session, i.e., a GTP tunnel, established between UE 101 and GGSN 105 via RNC 109, MFG 115, and SGSN 104. In one embodiment, message processor 125 also discovers other traffic information from the exchanged messages and storing them in IP mapping table 120, e.g., transport addresses of SGSN 104 and RNC 109, TEIDs, etc.

In FIG. 1B, for the purpose of illustration, according to one embodiment, WiFi equipped UE 101 moves within the coverage area of a WiFi network and initiates 802.1x based authentication with WiFi controller 110 in order initiate a handover procedure, i.e., to establish a data session via WiFi RAN 103. UE 101 can use any extensible authentication protocol (EAP) based authentication, such as EAP-subscriber identity module (EAP-SIM) and/or EAP-AKA protocols. A network access identifier (NAI) used in the IEEE 802.1x exchange contains the information identifying a mobile network operator (MNO) that informs an access point (AP) or WiFi controller 110 to initiate an EAP or a remote authentication dial-in user service (RADIUS) authentication session towards MFG 115. The EAP-AKA/EAP-SIM exchange may be completed against a 3G authentication, authorization, and accounting (AAA) server or home subscriber server (HSS). If the MNO network does not have a 3G AAA server, MFG 115 can fulfill this role and interact with the associated HSS directly. Upon successful authentication, MFG 115 is configured to convey encryption keys securely to WiFi controller 110.

According to one embodiment, when UE 101 moves in the WiFi coverage area 103, it would start the normal association and session establishment procedure with WiFi controller 110. As described above, during the WiFi session setup, an IP address is assigned to the WiFi capable UE 101. In one embodiment, the WiFi session setup may be the result of a handover attempt by UE 101, in which case, the IP address assigned by MFG 115 to UE 101 is the same IP address that was assigned to UE 101 during the original 3G data session setup (via the 3G RAN), as discussed above in the text relating to FIG. 1A. Alternatively, if the WiFi session setup is for a completely new session, rather than a handover, the WiFi capable UE 101 is assigned an IP address by the PDG/TTG.

By way of example, during a WiFi data session setup, message processor 125 may intercept authentication response messages from the PDG/TTG which contains an IP address assigned to UE 101. In one embodiment, message processor 125 determines if the IMSI corresponding to UE 101 exists in IP mapping table 120. If the IMSI exists in the table, message processor 125 may conclude that UE 101 already has an active 3G data session via RNC 109, and thus the data session over the WiFi RAN 103 is a handover session. In such a case, message processor 125 updates IP mapping table 120 to indicate that the same UE has now connected to the 3G CN via WiFi RAN 103, i.e., UE 101 has established a handover session through WiFi RAN 103. In addition, message processor 125 may replace the PDG/TTG assigned IP address with the IP address stored in IP mapping table 120 which is located at the entry belonging to the UE. MFG 115 then forwards the modified authentication response messages from the PDG/TTG to UE 101. Furthermore, subsequent data exchanges between UE 101 and the PDG/TTG will be routed through data path 116 as setup during the initial 3G data session via RNC 109. Thus, from the user's perspective, the handover from the 3G RAN to the WiFi RAN is seamless and uninterrupted.

On the other hand, if during a WiFi data session setup message processor 125 determines that the IMSI corresponding to UE 101 does not exist in IP mapping table 120, message processor 125 may conclude that UE 101 is establishing a brand new data session, rather than attempting a handover procedure. In such a case, if MFG 115 is configured to operate as a PDG, data traffic from UE 101 may be routed from WiFi Controller 110 to the PDG, and offloaded directly to Internet 107, without traversing through GPRS Core 106. Alternatively, MFG 115 may be configured to operate as a TTG, in which case, a GTP tunnel will be created between the TTG and GGSN 105. As a result, data traffic from UE 101 is sent by WiFi Controller 110 to the TTG, which is then tunneled to GGSN 105, destined for an IP network such as Internet 107.

In one embodiment, after UE 101 successfully establishes a data session via WiFi Controller 110 (i.e., after succeeding a handover procedure), it may attempt to tear down the data session which it currently has with the 3G CN 106 via RNC 109. In one embodiment, this is done by UE 101 sending a NAS level message “Deactivate PDP context request” to the 3G CN 106 via MFG 115. Alternatively, the data session tear down may be attempted by RNC 109 sending a RANAP level message “IU Release Request” to the 3G CN 106 via MFG 115. In one embodiment, message processor 125 determines that the NAS/RANAP message originates from a UE that is currently connected to MFG 115 via WiFi Controller 110, and blocks the messages from being forwarded to 3G CN 106, thus preventing the GTP tunnel via RNC 109 from being torn down, i.e., deactivated. Thus, in one embodiment, although the UE believes that the data connection through 3G RAN has been torn down, in reality, the data traffic originating from the UE continues to flow through the 3G RAN to the 3G CN. In fact, the 3G CN has no knowledge that the UE has transitioned to WiFi RAN 103, because this is hidden from the 3G CN by MFG 115. In one embodiment, message processor 125 determines that the NAS/RANAP message originates from a UE that is connected to MFG 115 via WiFi Controller 110 if IP mapping table 120 indicates that the UE currently has a handover session via WiFi RAN 103.

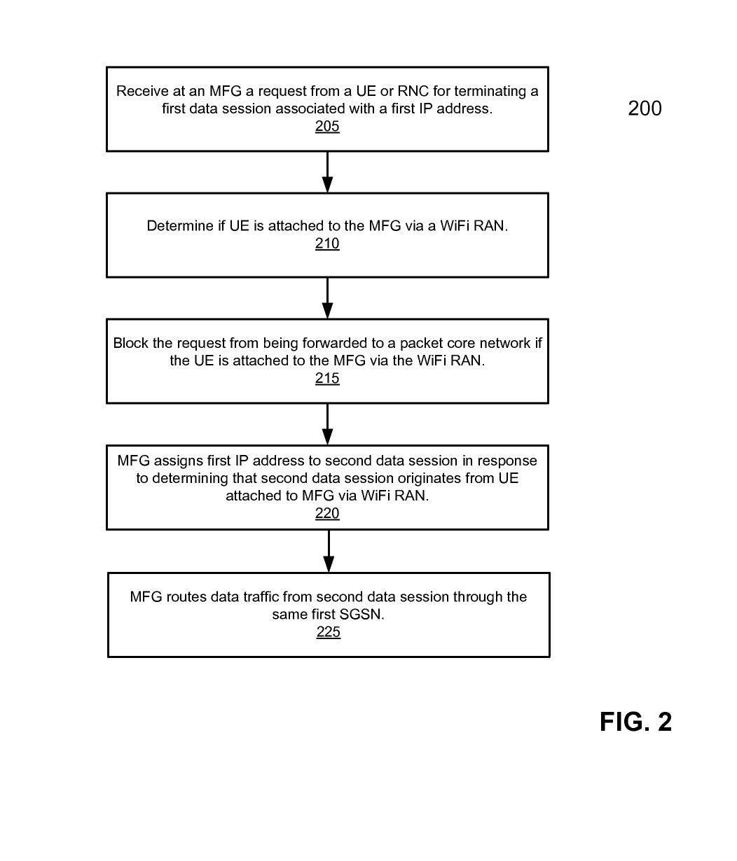

FIG. 2 is a flow diagram illustrating a method for seamlessly processing handover from a 3G RAN to a WiFi RAN according to one embodiment of the invention. For example, method 200 may be performed by MFG 115 of FIG. 1. Referring to FIG. 2, at block 205, in one embodiment, an MFG receives a request from a UE, or RNC on behalf of a UE, for terminating a first (i.e., existing) data session identified by a first IP address. In one embodiment, the first data session is routed from the RNC to a first SGSN through the MFG. At block 210, in response to receiving the request at block 205, the MFG determines if the request is from a UE which is also connected to the MFG via a WiFi RAN. In one embodiment, the MFG determines that the request is from a UE which is also connected to the MFG via the WiFi RAN if the UE' s unique identifier, e.g., its IMSI, is located in an IP mapping table entry which the MFG maintains, and the entry in the table indicates the UE has a handover session via a WiFi RAN. At block 215, the MFG intercepts and blocks the request received at block 205 from being forwarded to the 3G CN, if the MFG determines that the request is from a UE that is currently connected to the MFG via a WiFi RAN, as determined at block 210. At block 220, the MFG intercepts messages directed at the UE via the MFG, and replaces the PDG/TTG assigned IP address with the first IP address assigned to the UE via the 3G RAN. In other words, the IP address of the first data session that is to be terminated by the request received at block 205 is used to identify the UE in a new data session via the WiFi RAN. In one embodiment, this first IP address is an IP address stored in the IP mapping table maintained by the MFG. At block 225, the MFG routes data traffic of the second data session via the WiFi RAN through the same GTP tunnel as the first data session via the RNC. In one embodiment, this GTP tunnel is the tunnel established between the RNC and an SGSN flowing through the MFG.

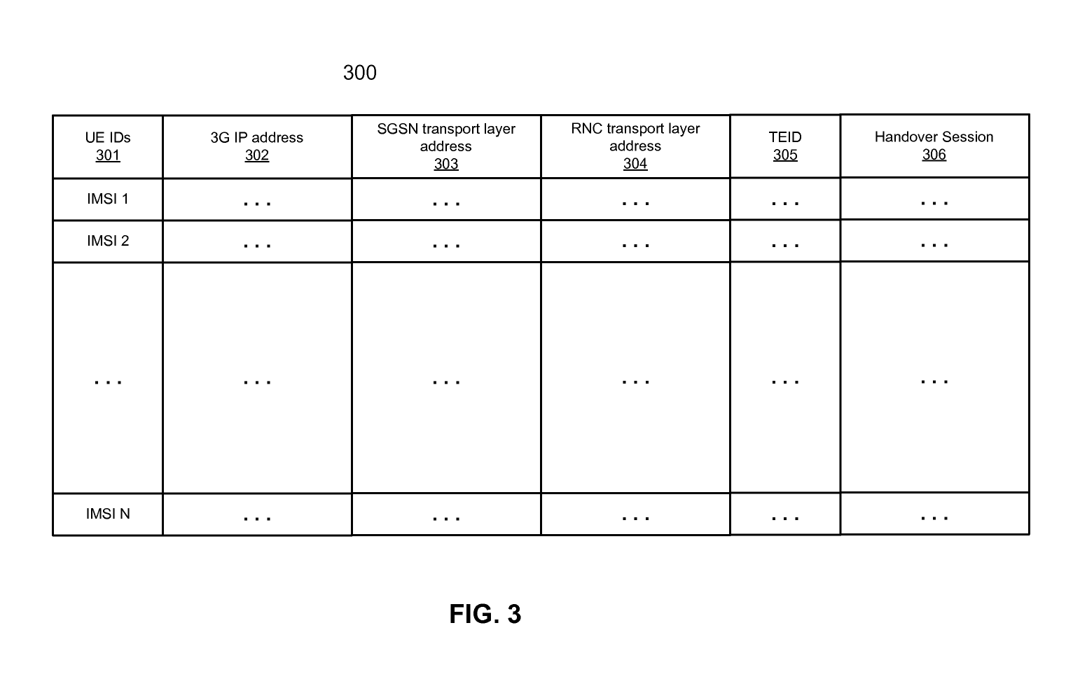

FIG. 3 illustrates an exemplary IP mapping table 300 which may be implemented as IP mapping table 120 of FIG. 1. In one embodiment, IP mapping table 300 includes one or more entries, each entry including contents which message processor 125 “learns” or “discovers” by parsing or looking into the frames that are exchanged between WiFi Controller 110/RNC 109 and 3G CN 106. For example, each entry may contain a unique identifier of the UE, e.g., IMSI (stored in element 301 of the entry); an IP address assigned to the UE, e.g., by the SGSN (stored in element 302 of the entry); a transport layer address of the SGSN and RNC (stored in elements 303 and 304, respectively); a TEID (stored in element 305); and an indication of whether the UE has connected to MFG 115 via WiFi RAN, i.e., whether the UE has a handover session established with the 3G CN via WiFi RAN 103 (stored in element 306 of the entry). The storage and usage of these elements of each entry shall become apparent in the discussion below. The contents, i.e., elements of each entry of IP mapping table 300 are discussed above for illustrative purposes only and not intended to be a limitation on the table. For instance, alternative embodiments of the invention may not include all the elements discussed. Yet in other embodiments, additional elements may be included in IP mapping table 300.

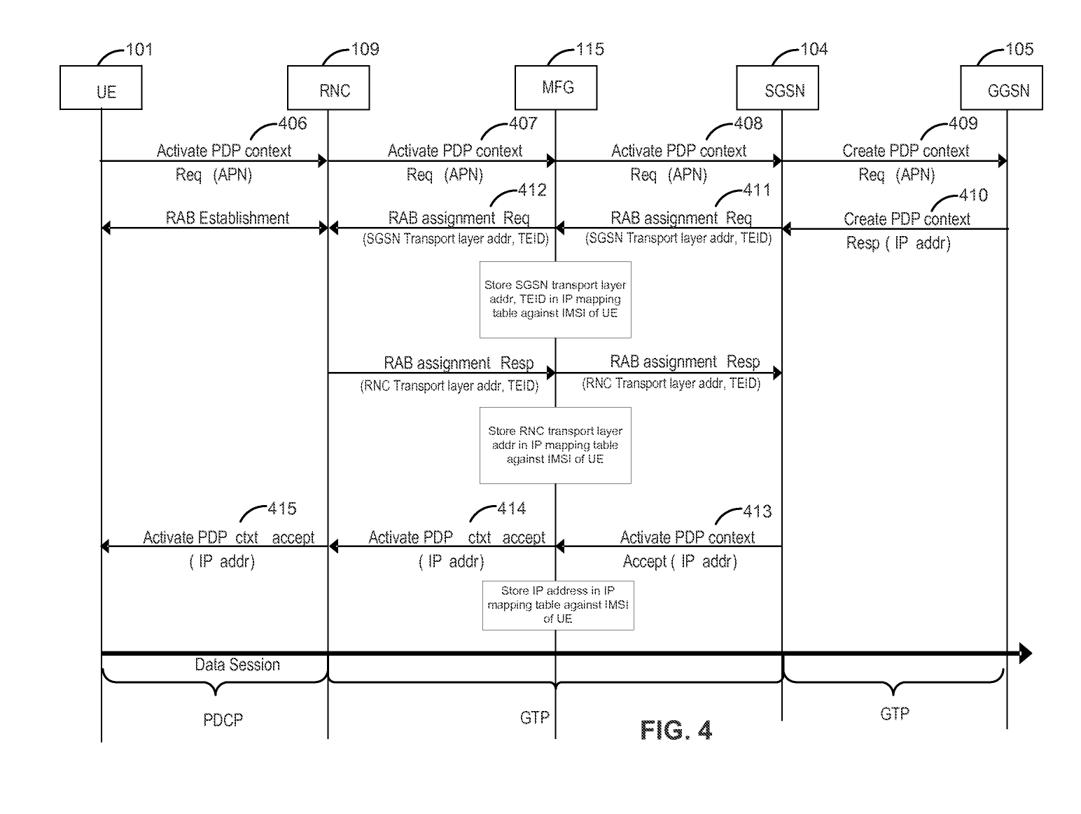

FIG. 4 is a transaction diagram illustrating a processing flow for handling data packets according to one embodiment of the invention. In particular, FIG. 4 illustrates a data session established between UE 101 and SGSN 104 as shown by the data connection 116 of FIG. 1. Referring to FIG. 4, when UE 101 attempts to establish a connection to access a node of an external network such as Internet 107 or operator's services node, UE 101 generates a PDP context request that contains an access point name (APN) and sends the request to RNC 109. PDP context request includes a PDP context which is a data structure present on both the SGSN and the GGSN which contains the subscriber's session information when the subscriber has an active session. When a UE wishes to use 3G data service, it first attaches and then activates a PDP context. This allocates a PDP context data structure in the SGSN that the subscriber is currently visiting and the GGSN serving the subscribers access point. The data recorded includes information regarding a subscriber's IP address, and subscriber's tunnel endpoint IDs (TEIDs) for SGSN and GGSN. In addition, an access point is selected and an APN is determined.

When MFG 115 receives the PDP context request forwarded from RNC 109 via transactions 406-407, MFG 115 relays the request to SGSN 104 which sends the request to GGSN 105 via transactions 408-409. In response to the request, GGSN 105 responds with an allocated IP address appropriate for the requested APN from its IP address pool and sends the response to SGSN 104 via transaction 410. In response, SGSN 104 sends a RAB (radio access bearer) assignment request to RNC 109, via MFG 115, having a SGSN transport layer address allocated by SGSN 104 and TEID via transactions 411-412. During transactions 411-412, again MFG 115 acts merely as a relay device. In response to the RAB assignment request, RNC 109 sends a RAB assignment response to SGSN 104 via MFG 115, which includes the RNC transport layer address and TEID. Once the RAB assignment has been completed, the activation of PDP context is completed via transactions 413-415 using an IP address allocated by GGSN 105. As a result, a GTP tunnel is created between RNC 109 and SGSN 104 and subsequent data for the session is exchanged between RNC 109 and SGSN 104 via the GTP tunnel. That is, all traffic has to go through SGSN 104 and GGSN 105 of the 3G packet core network. The MFG 115 simply acts as a relay device.

In one embodiment, message processor 125 of MFG 115 intercepts and processes messages between UE 101/RNC 109 and 3G CN 106 to discover information within the messages and store them in IP mapping table 300 of FIG. 3. In one embodiment, message processor 125 stores a unique identifier of the corresponding UE, e.g., its IMSI, in element 301 of an entry in IP mapping table 300 of FIG. 3. In addition, message processor 125 also stores in element 302 the IP address that has been assigned to UE 101 by GGSN 105 for the GTP tunnel created. In another embodiment, message processor 125 also stores the SGSN and RNC transport layer address in elements 303-304, respectively, and TEID in element 305 of an entry of IP table 300. The contents of IP mapping table 300 helps MFG 115 determine which UEs are currently connected to it, and via which RAN. Thus, for example, MFG 115 may conclude that a GTP tunnel exists between SGSN 104 and UE 101 via an RNC 109 if the IMSI corresponding to the UE can be located within table 300 of FIG. 3.

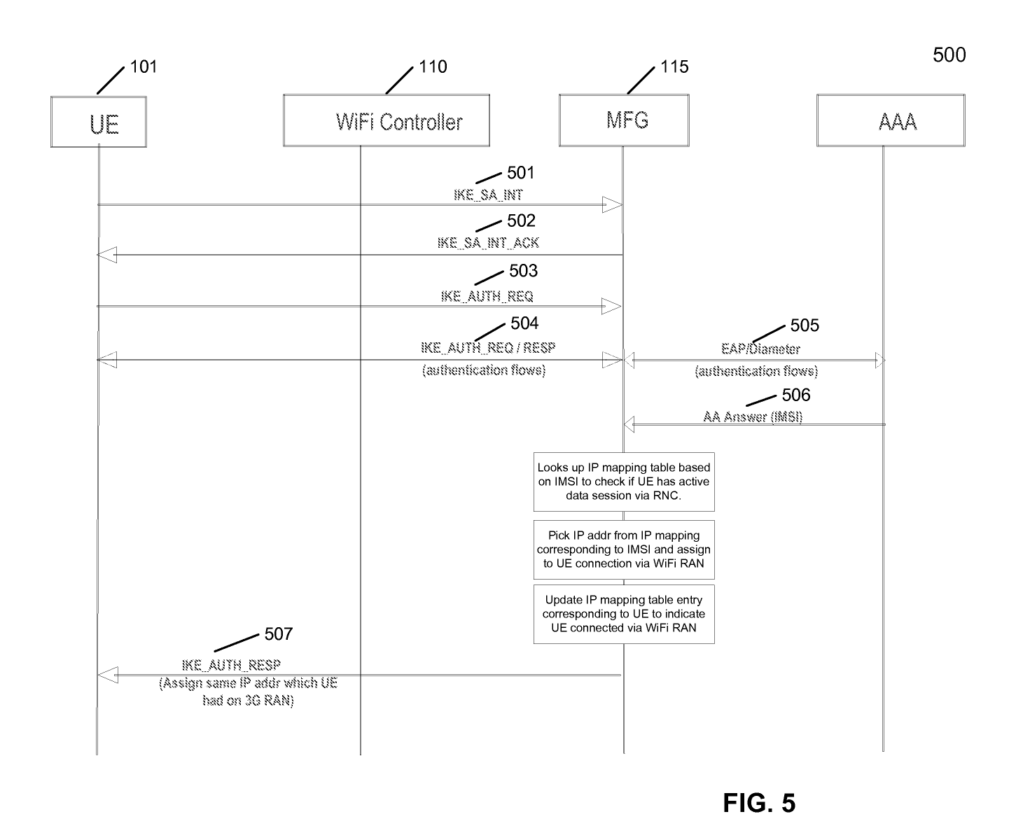

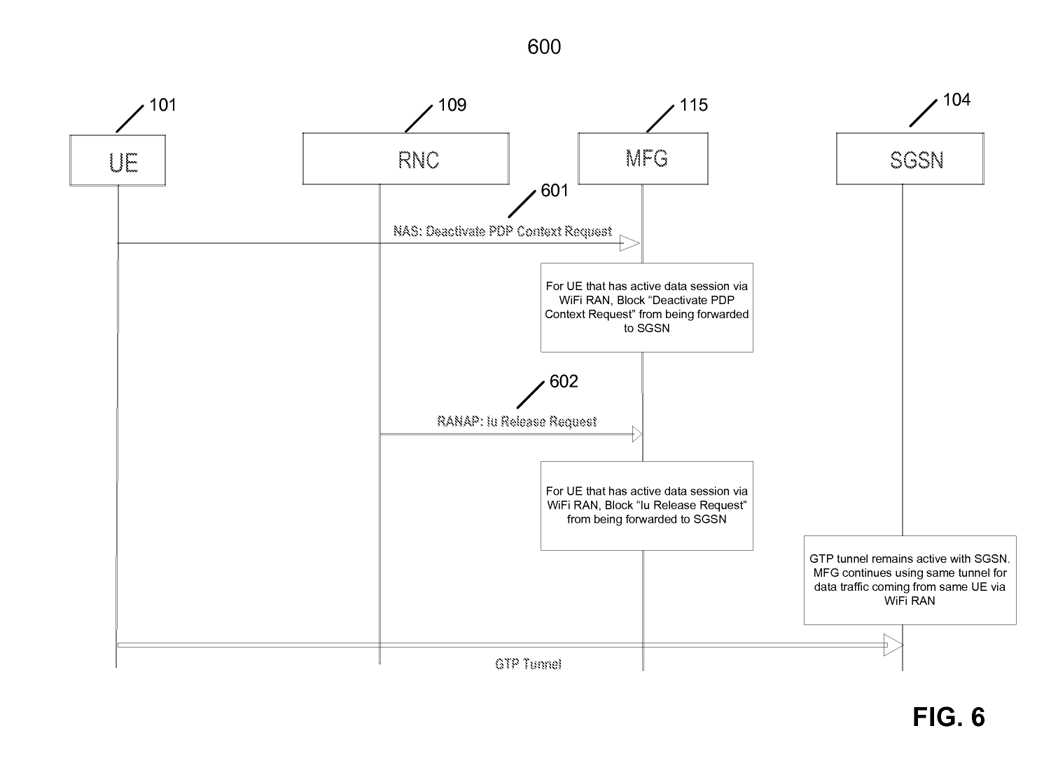

FIG. 5 is a transaction diagram illustrating a processing flow for handling control packets according to another embodiment of the invention. In particular, FIG. 5 illustrates a WiFi capable UE 101 performing a handover. Transactions 500 may be performed when a UE is attached to a WiFi network. Referring to FIG. 5, when UE 101 roams to a WiFi RAN (e.g., WiFi RAN 103 of FIG. 1), UE 101 initiates WiFi based authentication (e.g., IEEE 802.1x) with WiFi controller 110. For example, for WiFi, UE 101 can use EAP_SIM or EAP-AKA based authentication protocol. Based on a NAI obtained from the authentication transaction, WiFi controller 110 identifies MFG 115 that is associated with the corresponding WiFi. During transactions 501-503, UE 101 establishes an IKEv2/IPSec tunnel with MFG 115. Upon successfully establishing a secure tunnel with MFG 115, UE 101 authenticates with AAA/HSS server through transactions 504-505. At transaction 506, the authentication process is successfully completed. In one embodiment of the invention, MFG 115 next performs an IMSI-based look up of IP mapping table 300 of FIG. 3 to determine if UE 101 has an active 3G data session via 3G RAN 102. In one embodiment, MFG 115 determines that UE 101 has an active 3G connection via 3G RAN 102 if the IMSI corresponding to UE 101 is located in an entry of IP mapping table 300. In such an embodiment, MFG 115 assigns UE 101 with the same IP address from the same entry (e.g., the IP address found in element 302 of table 300 of FIG. 3). In one embodiment, MFG 115 also stores a predetermined value in element 306 of the same entry of table 300 to indicate that UE 101 has established a handover session with MFG 115 via WiFi RAN 103. As will be discussed in the text relating to FIG. 6, this helps MFG 115 in deciding whether or not to block data session tear down messages originating from UE 101 destined for 3G CN 106 of FIG. 1. At transaction 507, MFG 115 completes the authentication process with UE 101 by sending an authentication response message containing the same IP address which UE 101 has via the 3G RAN connection, i.e., the IP address found in element 302 of the IP mapping table 300 entry containing UE 101's IMSI.

FIG. 6 is a transaction diagram illustrating MFG 115 blocking data session tear down requests from UE 101 and RNC 109. In one embodiment, once UE 101 has successfully established a data session via WiFi RAN 109 as discussed in the text relating to FIG. 5, UE 101 attempts to tear down (i.e., deactivate) the 3G data session it established via 3G RAN 102, as discussed in the text relating to FIG. 4. Referring back to FIG. 6, at transaction 601, UE 101 attempts to deactivate the GTP tunnel established via 3G RAN 102 by sending a NAS level “Deactivate PDP Context Request” message. Traditionally, this message would be relayed by a gateway to SGSN 104, and the GTP tunnel would be deactivated. However, in one aspect of the present invention, MFG 115 blocks the message and prevents it from being forwarded to SGSN 104 when MFG 115 determines that the NAS message originated from UE 101 which is currently connected to it via WiFi RAN 103. In one embodiment, MFG 115 determines that the message originates from UE 101 which is connected to it via WiFi RAN 103 when the UE's IMSI exists in an entry of IP mapping table 300, and element 306 of the same entry contains a predetermined value which indicates the UE has a handover session via WiFi RAN 103. At transaction 602, RNC 109 attempts to tear down the GTP-U tunnel by sending a RANAP level “Iu Release Request” message” to SGSN 104 via MFG 115. Traditionally, this message would be forwarded to SGSN 104 by a gateway. However, in one embodiment of the present invention, MFG 115 determines that UE 101 has an active handover session via WiFi RAN 103 (as discussed above), and blocks the request from being forwarded to 3G CN 106. It should be appreciated from the discussion above that the GTP-U tunnel between RNC 109 and GGSN 105 remains active because the session tear down requests were blocked by MFG 115 and reached SGSN 104. Furthermore, in one embodiment of the invention, data traffic originating from UE 101 via WiFi RAN 103 will be forwarded to SGSN 104 using this active GTP tunnel, if MFG 115 determines that the WiFi data session is a handover session, as indicated by a predetermined value in element 306 of IP mapping table 300.

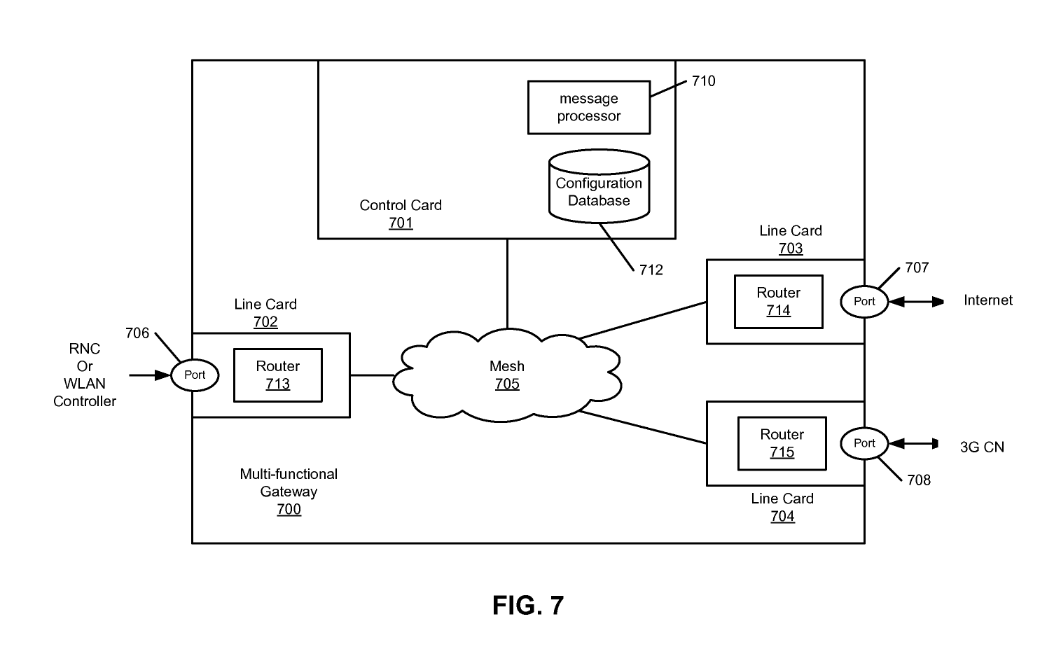

FIG. 7 is a block diagram illustrating a multi-functional gateway device according to one embodiment of the invention. For example, MFG 700 may be implemented as a part of MFG 115 of FIG. 1. Referring to FIG. 7, MFG 700 includes, but is not limited to, a control card 701 (also referred to as a control plane) communicatively coupled to one or more line cards 702-704 (also referred to as interface cards or user planes) over a mesh 705, which may be a mesh network, an interconnect, a bus, or a combination thereof. Each of the line cards 703-704 is associated with one or more interfaces (also referred to as ports), such as interfaces 706-708 respectively. Each line card includes routing functional block (e.g., blocks 713-715) to route packets via the corresponding interface according to a configuration (e.g., routing table) configured by control card 701. For the purpose of illustration, it is assumed that interface 706 is to be coupled to an RNC of a 3G RAN or a WiFi controller of a WiFi RAN; interface 707 is to be coupled to the Internet; and interface 708 is to be coupled to SGSN of a 3G packet core network for operator services.

According to one embodiment, control card 701 includes a configuration unit 709, a message processor 710, and a configuration database 712. In one embodiment, database 712 may be utilized to store an IP mapping table such as the IP mapping table 300 of FIG. 3. At least a portion of information stored in database 712 may be pushed down to line cards 702-704, for example, as part of a routing table (not shown).

Message processor 710 is configured to intercept messages between RANs and the 3G CN, and discover traffic information. For instance, message processor 710 may discover the transport layer addresses of SGSNs and RNCs. In another embodiment, message processor 710 may also discover TEIDs, IP addresses and IMSIs of UEs, as discussed above. In one embodiment, the traffic information discovered are stored in configuration database 712. In one embodiment, message processor 710 is configured to intercept and modify messages from the 3G CN (e.g., via interface 708) before forwarding them to the RANs. For example, message processor 710 may replace PDG/TTG assigned IP addresses in authentication responses with addresses found in database 710 before forwarding them to WiFi RAN 103. In one embodiment, message processor 710 is configured to intercept WiFi RAN messages and update database 710 to indicate which data sessions are handover sessions.

Note that some of the functionality of control card 701 may be delegated or replicated to a line card. For example, certain information of database 712 may be replicated to line cards 702-704 and stored in a storage location (not shown) within line cards 702-704. Also note that some or all of the components as shown in FIG. 7 may be implemented in hardware, software, or a combination of both.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable medium. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., carrier waves, infrared signals, digital signals, etc.)), etc.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description above. In addition, embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A machine-implemented method for processing network traffic of a packet core network, the method comprising:
receiving, at a multi-functional gateway (MFG), a request for terminating a first data session identified by a first IP address, the request originated either directly from a user equipment (UE), or indirectly from the UE via a 3G radio access controller (RNC) of a 3G radio access network (3G RAN), wherein data traffic of the first data session originated from the UE via the 3G RAN is routed to a first serving GPRS support node (SGSN) of the packet core network by the MFG;
determining, by the MFG, whether the UE is communicatively coupled to the MFG via a WiFi radio access network (WiFi RAN), in response to receiving the request for terminating the first data session; and
blocking, by the MFG, the request to terminate the first data session from being forwarded to the packet core network, in response to determining by the MFG that the UE is communicatively coupled to the MFG via the WiFi RAN.

2. The method of claim 1, further comprising assigning, by the MFG, the first IP address to a second data session established by the UE via the WiFi RAN, and routing, by the MFG, data traffic of the second data session through the first SGSN.

3. The method of claim 1, further comprising maintaining, by the MFG, an IP mapping table comprising one or more entries, wherein each entry comprises one or more elements, wherein the UE is determined to be communicatively coupled to the MFG via the WiFi RAN if a first element of a first entry contains an international mobile subscriber identifier (IMSI) of the UE, and a second element of the first entry contains a predetermined value which indicates that the UE is communicatively coupled to the MFG via the WiFi RAN.

4. The method of claim 3, wherein the first entry of the IP mapping table further comprises a third element containing the first IP address, which was assigned by the GGSN of the packet core network to the UE during the first data session via the 3G RAN.

5. The method of claim 4, wherein the first entry of the IP mapping table further comprises a fourth element for storing a SGSN transport layer address, a fifth element for storing a RNC transport layer address, and a sixth element for storing a subscriber's tunnel endpoint ID (TEID).

6. The method of claim 1, wherein the request for terminating the first data session originated indirectly from the UE via the 3G RNC is a RANAP message, and the request for terminating the first data session originated directly from the UE is a NAS message.

7. A network apparatus, comprising:
an interface to receive a request for terminating a first data session identified by a first IP address, the request originated either directly from a user equipment (UE), or indirectly from the UE via a 3G radio access controller (RNC) of a 3G radio access network (3G RAN), wherein data traffic of the first data session originated from the UE via the 3G RAN is routed to a first serving GPRS support node (SGSN) of the packet core network by the network apparatus;
a message processor to determine whether the UE is communicatively coupled to the network apparatus via a WiFi radio access network (WiFi RAN), in response to receiving the request for terminating the first data session, and to block the request to terminate the first data session from being forwarded to the packet core network, in response to determining that the UE is communicatively coupled to the network apparatus via the WiFi RAN.

8. The network apparatus of claim 7, further comprising assigning, by the network apparatus, the first IP address to a second data session established by the UE via the WiFi RAN, and routing, by the network apparatus, data traffic of the second data session through the first SGSN.

9. The network apparatus of claim 7, further comprising maintaining, by the network apparatus, an IP mapping table comprising one or more entries, wherein each entry comprises one or more elements, wherein the UE is determined to be communicatively coupled to the network apparatus via the WiFi RAN if a first element of a first entry contains an international mobile subscriber identifier (IMSI) of the UE, and a second element of the first entry contains a predetermined value which indicates that the UE is communicatively coupled to the network apparatus via the WiFi RAN.

10. The network apparatus of claim 10, wherein the first entry of the IP mapping table further comprises a third element containing the first IP address, which was assigned by the GGSN of the packet core network to the UE during the first data session via the 3G RAN.

11. The network apparatus of claim 10, wherein the first entry of the IP mapping table further comprises a fourth element for storing a SGSN transport layer address, a fifth element for storing a RNC transport layer address, and a sixth element for storing a subscriber's tunnel endpoint ID (TEID).

12. The network apparatus of claim 7, wherein the request for terminating the first data session originated indirectly from the UE via the 3G RNC is a RANAP message, and the request for terminating the first data session originated directly from the UE is a NAS message.

13. A non-transitory machine-readable storage medium storing instructions therein, which when executed by a processor, cause the processor to perform a method for processing network traffic of a data network, the method comprising:
receiving, at a multi-functional gateway (MFG), a request for terminating a first data session identified by a first IP address, the request originated either directly from a user equipment (UE), or indirectly from the UE via a 3G radio access controller (RNC) of a 3G radio access network (3G RAN), wherein data traffic of the first data session originated from the UE via the 3G RAN is routed to a first serving GPRS support node (SGSN) of the packet core network by the MFG;
determining, by the MFG, whether the UE is communicatively coupled to the MFG via a WiFi radio access network (WiFi RAN), in response to receiving the request for terminating the first data session; and
blocking, by the MFG, the request to terminate the first data session from being forwarded to the packet core network, in response to determining by the MFG that the UE is communicatively coupled to the MFG via the WiFi RAN.

14. The non-transitory machine-readable storage medium of claim 13, further comprising assigning, by the MFG, the first IP address to a second data session established by the UE via the WiFi RAN, and routing, by the MFG, data traffic of the second data session through the first SGSN.

15. The non-transitory machine-readable storage medium of claim 13, further comprising maintaining, by the MFG, an IP mapping table comprising one or more entries, wherein each entry comprises one or more elements, wherein the UE is determined to be communicatively coupled to the MFG via the WiFi RAN if a first element of a first entry contains an international mobile subscriber identifier (IMSI) of the UE, and a second element of the first entry contains a predetermined value which indicates that the UE is communicatively coupled to the MFG via the WiFi RAN.

16. The non-transitory machine-readable storage medium of claim 15, wherein a third element of the first entry contains the first IP address, which was assigned by the GGSN of the packet core network to the UE during the first data session via the 3G RAN.

17. The non-transitory machine-readable storage medium of claim 16, wherein the first entry of the IP mapping table further comprises a fourth element for storing a SGSN transport layer address, a fifth element for storing a RNC transport layer address, and a sixth element for storing a subscriber's tunnel endpoint ID (TEID).

18. The non-transitory machine-readable storage medium of claim 12, wherein the request for terminating the first data session originated indirectly from the UE via the 3G RNC is a RANAP message, and the request for terminating the first data session originated directly from the UE is a NAS message.
